(19) United States
(12) Patent Application Publication
(10) Pub. No.: US 2005/0113592 A1
(43) Pub. Date: May 26, 2005

(54) Method for preparing chlorosilane

(75) Inventors: Roland Wagner, St. Augustin (DE); Ralf Maecker, Leverkusen (DE); Hubertus Eversheim, Wermelskirchen (DE); Horst Lange, Bochum (DE)

Correspondence Address: NORRIS, MCLAUGHLIN & MARCUS, P.A., 875 THIRD AVE, 18TH FLOOR, NEW YORK, NY, 10022, US

(73) Assignee: GE Bayer Silicones GmbH & Co., Leverkusen (DE)

(21) Appl. No.: 10/910,946

(22) Filed: Aug. 4, 2004

(30) Foreign Application Priority Data
Aug. 5, 2003 (DE) 103 36 545.1

(51) Int. Cl. C07F 7/04

(52) U.S. Cl. 556/472

(57) ABSTRACT

The invention relates to a process for manufacturing chlorosilanes, in which methyl-rich disilane, polysilane and siloxane residues from the Müller-Rochow synthesis or a chlorosilane synthesis are reduced in quantity. It comprises the steps: a) reaction of silicon with alkyl halogenides, aryl halogenides or hydrogen chloride, b) reaction of at least one high-boiling product fraction from step a) with at least one halogenide and c) reaction of at least one high-boiling product fraction resulting from step b) with alkyl halogenides, aryl halogenides and/or chlorosilanes.

The invention relates to a method for manufacturing chlorosilanes, especially a method for manufacturing chlorosilane in which methyl-rich polysilane and siloxane residues from the Müller-Rochow synthesis or a chlorosilane synthesis in which they are converted into lower-boiling product fraction are reduced.

The Müller-Rochow synthesis for manufacturing dimethyl dichlorosilane and other silanes having alkyl, halogen and SiH functions from silicon, methyl chloride and Cu-based catalysts leads to an unavoidable precipitation of other byproducts after separation of the target products using cyclone systems and distillation.

This means that a fine silicon portion occurs that contains significant quantities of a very broad spectrum of metal, metallic compounds and metal halogenides, especially of Cu, Al, Zn, Sn. This fine portion is usually deposited after passivation or used as raw material for metal casting or as a slag-forming additive for steel works. Washing this fine portion intensively with silanes and supplying it back to the Müller-Rochow synthesis has already been suggested. Alternatively, this fine portion can be converted into halogen silane with HCl or Cl₂ in a complicated high-temperature process. Treatment of the fine portion of silicon with HCl in an inert solvent has also already been described (JP 3248390 B2 equivalent to JP 8277104).

After isolation of the main products of the Müller-Rochow synthesis, a high-boiling, often liquid, residue remains that consists of a complex mixture of mainly polysilane, mixed with siloxanes and carbosilane. Halogen disilane can be split with alkyl halogenides and CuCl (U.S. Pat. No. 2,474,087). Splitting these high-boiling compounds with HCl in the presence of tertiary amines into useful halogen silane is also known (U.S. Pat. No. 2,709,176, U.S. Pat. No. 2,842,580). Another possibility for reducing the high-boiling compounds consists of converting them to monomer chlorosilane and oligomer silane without the addition of HCl in the presence of amines and/or ammonium compounds (EP 0 610 809), whereby the disilane is disproportionated into monomeric and oligomeric alkyl halogen disilane with the use of heterocyclic amines with at least one N atom. To do this, DD 274 227 discloses further catalysts like alkyl ureas or hexamethyl phosphoric acid triamide (HMPTA).

Reacting high-boiling components like the disilane of the methyl chlorosilane synthesis in the presence of catalysts like amines, amides or quaternary ammonia salts and hydrogen chloride has been suggested, under the condition that the quantity of Fe, Al, Zn, Sn and their available bonds in the reaction system is less than the equimolar quantity of the catalysts (U.S. Pat. No. 5,922,893). U.S. Pat. No. 5,502,230 discloses the reaction of high-boiling disilanes of direct synthesis with HCl in the presence of Pt or Pd based catalysts to which tertiary amines or phosphines are added.

A second solution for splitting these high-boiling compounds starts with a catalytic base system HCl/AlCl₃. In this case, the additions of SbCl₅ are supposed to have a positive effect on the catalytic activity (U.S. Pat. No. 5,629,438). Alternatively, methyltrichlorosilane is added to the HCl/AlCl₃ system to improve the silane yield (U.S. Pat. No. 5,627,298). The addition of hydrogen to HCl/AlCl₃ has also been described (U.S. Pat. No. 5,292,909, U.S. Pat. No. 5,292,912).

Another solution for the separation of high-boiling compounds starts with hydrogen-containing systems in the absence of HCl. The combination H₂/AlCl₃ has been described here (JP 2001064008, U.S. Pat. No. 5,326,896, U.S. Pat. No. 5,430,168). U.S. Pat. No. 6,013,235, as well as U.S. Pat. No. 6,344,578 (EP 1179534) discloses the simultaneous reaction of silicon (silicon metalloids) available in this process to chlorosilane at temperatures of 150-500° C. An improvement in the H₂/AlCl₃ system is to be achieved by an addition of SbCl₅ (U.S. Pat. No. 5,606,090). An ‘in situ’ formation of AlCl₃ is achieved with the system H₂/CaCl₂+Al₂O₃/methyl-trichlorosilane/Pd—Pt (U.S. Pat. No. 5,175,329, U.S. Pat. RE No. 35,298).

A process is disclosed here in which disilane from direct synthesis is hydrated catalytically.

The combination of LiAlH₄/H₂ was also recognized as advantageous (U.S. Pat. No. 5,922,894). Finally, HCl-free and H₂-free separation reactions are also known. Reaction of disilanes with alkylhalogenides in the presence of special phosphine catalysts containing Pd, Ni and/or Pt will also lead to monosilanes (U.S. Pat. No. 3,772,347). In addition, reacting hexamethyl disilane with tetramethyl dichlorodisilane in the presence of AlCl₃ to produce useful products is also known (U.S. Pat. No. 4,266,068).

U.S. Pat. No. 4,393,229 (DE 3314734) claims a process for treating residues containing alkyl-rich disilanes that comprises the steps of reacting the residues with alkyl trihalogen silanes or silicon tetrahalogenide in the presence of a catalyst and a catalytic quantity of a hydrogensilane reaction promoter at elevated temperatures in order to create a disproportionating and/or rearrangement product containing disilane and dialkyl dihalogen silane with a greater amount of halogen.

Hydrogen silane is described as a possible alternative hydrogen source.

The description also discloses that this process can be used to convert the residues of disilane separation that can no longer be separated and/or disilanes that had to be previously burnt into separable high-quality products.

EP 155626 describes a process for manufacturing dimethyl dichlorosilane from the low-boiling and high-boiling byproducts of direct synthesis of methyl chlorosilanes that is characterized in that methyltrichlorosilane with the low-boiling components having a high percentage of methyl groups are brought into reaction simultaneously with the non-separable high-boiling components in the presence of a catalyst at temperatures between 250° C. and 400° C. and under a pressure up to 100 bar.

EP 869129 (U.S. Pat. No. 5,877,337) claims a continuous process for manufacturing alkyl chlorosilanes from the residues of direct synthesis of alkyl chlorosilanes that have liquid components with a boiling point of at least 70° C. at 1013 hPa and solids, by heating the residues with hydrogen chloride at temperatures from 300 to 800° C. in a tubular reactor with rotating inserts. EP 1179534_ B1 (U.S. Pat. No. 6,344,578) discloses how the solid-containing residues of the Müller-Rochow synthesis are converted into silicon tetrachlorosilane and trichlorosilane with HCl over 300° C. It is also supposed to be possible to separate polysilane with HCl/silicon.

EP 574912 (U.S. Pat. No. 5,288,892) claims a process for obtaining methyl chlorosilanes from high-boiling residues of the methyl chlorosilane synthesis, whereby separable methyl chlorodisilane present in the residues is separated with hydrogen chloride in the presence of a catalyst remaining in the reaction mixture, characterized in that the separation of the methyl chlorodisilanes proceeds in the presence of the volatile byproducts that are lighter than the separable methyl chlorodisilanes of the high-boiling residues of the methyl chlorosilane synthesis that have a boiling point of at least 70° C. under normal conditions, whereby the more volatile byproducts are removed continuously from the reaction mixture with the methyl chlorosilanes and the non-separable methyl chlorodisilanes. Tertiary amines are disclosed as catalysts.

However, none of these examples shows either how the non-separable disilane (fractions 1 and 2, Table 1=medium-boiling compounds) can be transformed into low-boiling products, or whether this process also transforms those components into low-boiling chlorosilane, which have a boiling point that lies over those disilanes in Example 2 named there and would belong to fraction 4 of the Table on page 2. FIG. 2 of EP 574912 A1 with the process flow chart according to the invention provides for no return of the high-boiling compound remaining in the sump of column tank 16 to e.g. the tank 13, i.e. a reaction tank prior to the product stream and/or process sequence.

The disadvantage of all the preparation suggestions mentioned above lies, first, in that the solid discharge and/or fine portion and the high-boiling fraction will be treated in isolation from each other, which essentially leads to a great deal of technical effort, since each reaction has to be carried out separately and represents an independent process step.

Many of the processing variations referred to for the high-boiling percentage above 150° lead to an unsatisfactory reaction, so that unavoidable yield streams continue to have to be burnt, incurring high costs. The handling of a few of the reactions suggested for the high-boiling compounds (e.g. H₂, LiAlH₄) under the technical conditions of direct synthesis requires further additional high safety expenses. The treatment solutions referenced, i.e. passivation or separation of the finest portion (<5 μm) are very solvent-intensive or also thermally very complicated, depending on the form.

The object of the invention is to provide a process for manufacturing chlorosilanes in which the portion of high-boiling compounds can be reduced to a great extent with the use of existing common system parts of the Müller-Rochow synthesis. These include the unit for separation of disilanes with hydrogen chloride, which is usually present, and the unit with a “slurry evaporator,” i.e. slurry tank.

The present invention thus provides a process for manufacturing chlorosilanes that comprises the steps:
a) reaction of silicon with alkyl halogenides, aryl halogenides or hydrogen chloride,
b) reaction of at least one high-boiling product fraction from step a) with at least one halogenide and
c) reaction of at least one high-boiling product fraction resulting from step b) with alkyl halogenides, aryl halogenides and/or chlorosilanes.

The chlorosilanes produced using the process according to the invention contain, for example: alkyl chlorosilane, aryl chlorosilane, alkylhydrogen chlorosilane, alkylaryl chlorosilane, hydrogen chlorosilane and perchlorosilane. Alkyl chlorosilanes are especially preferred according to the process of the invention, like dimethyl dichlorosilane, methyl trichlorosilane, dimethyl chlorosilane and methyl dichlorosilane. Preferred aryl chlorosilane that can be manufactured using the process according to the invention include, for example diphenyl dichlorosilane and phenyltrichlorosilane. Preferred hydrochlorination products obtained using the process according to the invention include hydrogenchlorosilane and perchlorosilane, e.g. especially hydrogen trichlorosilane, tetrachlorosilane and dihydrogendichlorolosilane.

Step a)

Step a) of the process comprises the Müller-Rochow synthesis carried out in a known way with alkyl halogenides or aryl halogenides or the various processes of hydrochlorination of silicon.

Alkyl halogenides that are included in step a) include e.g. a C1 to C8 alkyl halogenide, e.g. methyl chloride, ethyl chloride, butyl chloride and hexyl chloride. Methyl chloride is especially preferred. Aryl halogenides that can be used in step a) include e.g. C6-C10 aryl halogenides, e.g. preferably chlorobenzene.

The following can be named as an example of the silicon that can be used in step a): L. Nygaard ‘Alloying of Silicon and its Influence on Reactivity’in Silicon for Chemical Industry P. 47 ff. Geiranger Norway 1992, Ed.: H. A. Oeye u. H. Rong.

It is known that, in the reactions according to step a), catalysts are used that mainly consist of copper and/or copper compounds and that contain zinc or tin or their compounds as so-called promoters. In addition, other promoters can be included: elements of the 5^{th} main group, e.g. phosphorous, arsenic, antimony or their compounds; of the 3^{rd} main group, e.g. boron, aluminum and indium or their compounds. Aryl chlorosilanes are especially manufactured with the use of catalysts containing silver.

In addition, it is known that the silicon used for the process, due to its raw material and due to selective raffination, contains a series of catalytically active components, e.g. Cu, Zn, Sn, Al, Fe, Ca, Mn, Ti, Pb, Cr, Mg, Ni, B and P.

The known process of the Müller-Rochow synthesis and the hydrochlorination of silicon are described, for example in EP 191502; U.S. Pat. No. 4,500,724; U.S. Pat. No. 4,307,242; U.S. Pat. No. 4,281,149; and U.S. Pat. No. 4,130,632.

The reaction conditions for step a) are known. The reactions are generally carried out in a temperature range of about 170 to 600° C., at pressures of about 0.3 to 30 bar, preferably in a gas-solid reaction. Preferably reactors like stirred bed, (turbulent) fluidized bed, gusher and fluidized bed reactors are used, but also blast furnaces. The reaction most preferably takes place in an (turbulent) fluidized bed reactor.

The process according to the invention is applicable for all known Müller-Rochow syntheses and the processes of hydrochlorination of silicon. Preferably, it is used in the scope of the Müller-Rochow synthesis with alkyl halogenides, e.g. especially methyl chloride.

In step a), mainly the desired products described above are formed, e.g. mainly dimethyl dichlorosilane with the use of methyl chloride as halogenide. However, in addition, the formation of higher-boiling products also occurs, as is shown in the following Table 1 using the various products of the reaction of methyl chloride with silicon as an example.

TABLE 1
Example composition of the high-boiling methyl chlorosilane of the
Müller-Rochow synthesis

72-140° C. N.D. Fraction 1
Ethylmethyl dichlorosilane ¹⁾
Methylpropyl dichlorosilane
Ethyldimethyl chlorosilane
Tetramethyl dichlorodisiloxane
Trimethyl trichlorodisiloxane
Hexamethyl disilane
Hydrocarbons
140-155° C. N.D. Fraction 2
Pentamethyl chlorodisilane
Tetramethyl dichlorodisilane ¹⁾
Trimethyl trichlorodisilane
Dimethyl tetrachlorodisilane
Dimethyl tetrachlorodisiloxane incl. Disiloxanes and C2-C4-
disilanes
155-160° C. N.D. Fraction 3
Trimethyl trichlorodisilane ¹⁾
Dimethyl tetrachlorodisilane ¹⁾
160° C. N.D. Fraction 4
Oligomethyl chlorooligosilanes
Carbosilanes, like
Bis-Methyl dichlorosilylmethylene
1,1,1-(Trichlorosilyl)(methyl dichlorosilyl)methylene
and homologs
Higher-boiling Methyl chlorosiloxanes
¹⁾ Main component
N.D. = Standard Pressure 1013 hPa

The chlorosilanes to be added in the reaction steps b) to c) are preferably mono, di and trichlorosilane that are alkyl and/or H substituted. For example, HSiCl₂CH₃, HSiCl(CH₃)₂, SiCl₃CH₃, HSiCl₃, SiCl₂(CH₃)₂, SiCl(CH₃)₃, SiCl₄, Si(CH₃)₄, Si₂Cl₅(CH₃), Si₂Cl₄(CH₃)₂, Si₂Cl₃(CH₃)₃, Si₂Cl₂(CH₃)₄, Si₂Cl(CH₃)₅ and Si₂(CH₃)₆ are named. Preferably, these silanes are used as a mixture.

According to the invention, in step b), at least one high-boiling product fraction from step a), the Müller-Rochow synthesis and/or the hydrochlorination process is reacted with halogenides.

The high-boiling fraction from step a) contains one or more fractions. The named high-boiling fractions include basically all fractions that have a boiling point lying above the boiling product [sic] of the desired target product. The definition of the high-boiling product fraction(s) thus depends especially on the type of reaction carried out in step a), the starting materials used and the distillation separating steps carried out previously. The named target product usually represents the predominantly formed product of the process according to the invention for manufacturing chlorosilanes and/or methyl chlorosilanes. One or more target products can be formed. In particular, in the Müller-Rochow synthesis with methyl chloride, generally one product occurs as the main product, namely dimethyl dichlorosilane. In the case of hydrochlorination with hydrogen chloride, generally two target products are obtained as main products, namely trichlorosilane and tetrachlorosilane. If several target products are present, in step b), the high-boiling product fraction(s) used are those with a boiling point that lies above the boiling point of the higher-boiling target product. Thus, in the case of the Müller-Rochow synthesis with methyl chloride, dimethyl dichlorosilane represents the desired target product. It has a boiling point of 70° C. under normal pressure (ND=normal pressure=1013 mbar). Thus, the high-boiling product fractions from step a) in this case include basically all product fractions that boil above 71°, preferably above 73° C., and more preferably above 100° C.

According to the invention, one or more of the high-boiling product fractions formed in step a) can be used in step b). This includes especially, and preferably according to the invention, the variations in which the entire fraction that boils above the boiling point of the desired target product (and/or the desired target products) are added to step b) and those for which only the high-boiling compounds with boiling points above 160° C. N.D. and the solids are guided past this reaction step. In addition, it is possible according to the invention to separate the fraction that boils above the boiling point of the desired target product (and/or the desired target products) into at least two partial fractions using distillation and to add one or more of the resulting partial fractions to step b).

Step b)

In step b), at least one high-boiling product fraction from step a), as explained above, is reacted with at least one halogenide. The halogenide includes e.g. hydrogen chloride, alkyl halogenide, aryl chloride or allyl chloride. With respect to the named alkyl halogenides and aryl halogenides, due to the preferred examples, reference can be made to the comments regarding step a). Hydrogen chloride is especially preferably used in step b) as a halogenide. Under the conditions in step b), there is especially addition of the named halogenides to the compounds contained in the high-boiling product fraction(s) used, as well as to subsequent substitution reactions with formation of low-boiling chlorosilanes that consist mainly of the target product when there is an excess of the halogenide. The lower-boiling fraction is preferably added to the separating unit downstream of the chlorosilane synthesis according to step a). Separation results due to the vapor pressure of the low-boiling chlorosilane fraction in step b). The addition of the halogenides to the compounds of the high-boiling fractions in step b) preferably takes place on the disilanes contained in the named fraction, as in the case of the trimethyltrichlorodisilane and dimethyltetrachlorodisilane preferably contained in the Müller-Rochow synthesis. In step b), methyl-rich disilanes and polysilanes are produced that both occur in the form of a remaining Fr. 2 with modified composition and also in the sump discharge of step b) and are transferred to step c).

The higher boiling fraction, the sump discharge, from reaction step b), thus, in the case of the Müller-Rochow synthesis with boiling points above 155° C. N.D., is added to reaction step c). Also, all remaining residues of the 71-150° C. N.D. fraction (especially Fr. 1+2) from the separating unit following step a) are added to the reaction step c).

Step b) is preferably carried out at temperatures from about 30 to about 500°, preferably about 140 to 300° in a pressure range of preferably about 0.3 to about 50 bar, more preferably 2 to 10 bar.

The reaction according to step b) preferably takes place in the presence of catalytically active compounds. These types of compounds include e.g.: tertiary amines or salts thereof and quaternary ammonia salts, organic acid amides, alkyl and arylphosphine, Lewis acids like aluminum trichloride, iron trichloride, copper-(I) and (II) chloride, boron trichloride, tin tetrachloride, precious metal compounds in the form of salts and complex compounds of metals of the platinum group (palladium, ruthenium, iridium, rhodium, platinum, nickel, silver, gold, etc.). Preferably tertiary amines or salts thereof and quaternary ammonia salts are used (the named catalytically active compounds are identified as compound (2). Especially preferably used as (2) compounds are tertiary C1 to C12 alkylamines, aliphatic, monocyclic and polycyclic amines and aromatic heterocyclic nitrogen compounds, their salts and their quaternization products. According to the invention, imidazole, tributylamine, trihexylamine and dimethyloctylamine are especially preferred.

The invention also includes the case in which step b) is carried out in the presence of solid discharge from the chlorosilane synthesis reactor of step a). In this case, the compounds contained therein act as catalysts.

The presence of the catalysts named in step b) is preferred.

In addition to the lower-boiling fraction named above, which mainly contains other target products, i.e. in the case of the Müller-Rochow synthesis, dimethyl dichlorosilane, methyltrichlorosilane and methylhydrogen dichlorosilane, thus <71° C., in step b), a high-boiling fraction is formed that is used in the following step c). Similarly to the explanations given above regarding step a), the high-boiling product fraction from step b) basically involves all the products that boil above the boiling point of the target product, i.e. in the case of the Müller-Rochow synthesis with methyl chloride, in turn all fractions that boil above 71° C. N.D, preferably 73° and most preferably 100° C. N.D. Here, as well, it is preferably the entire product fraction that boils above the boiling point of the target product that is used in the following step c). However, it is also possible to use one or more high-boiling partial fractions in the following step c). The high-boiling product fraction and/or high-boiling product fractions taken from step b) differ from the high-boiling fractions taken from step a), especially in that the percentages of disilanes that can be reacted with halogenides according to process b) are lower.

The molar ratio of the quantity of the halogenide used in step b) related to the quantity of the high-boiling product fraction used depends especially on the content of reactive disilanes in the high-boiling product fraction taken from step a) and is e.g. about 1 to 1:2 related to the trimethyltrichlorodisilane and dimethyltetrachlorodisilane contained in the high-boiling product fraction.

The reaction of step b) can be carried out in a gas-liquid or a gas-gas phase reaction, e.g. in a reaction tank or a reaction column.

Step c)

The further reaction of at least one high-boiling fraction resulting from step b) with alkyl halogenides, aryl halogenides and/or chlorosilanes occurs in the following step c). Reference can be made to the explanations given above in connection with step b) regarding the high-boiling product composition resulting from step b).

Preferably, in step c), the reaction of the high-boiling product fraction resulting from step b) with alkyl halogenides, aryl halogenides or chlorosilanes takes place. Preferably, the alkyl halogenide used in step c) is selected from the group that consists of C1 to C8 alkyl halogenides, e.g. methyl chloride, ethyl chloride, butyl chloride and hexyl chloride, C2 to C6 alkenyl halogenides, like allyl chloride and C6-C10 aryl halogenides, for example chlorobenzene, chlorosilanes, like dimethyl dichlorosilane, methyltrichlorosilane, methylhydrogendichlorosilane, tetrachlorosilane, hexaclorodisilane, tetramethyl dichlorodisilane, other alkyl disilanes containing chlorine and as named carbosilanes in Table 1 under Fraction 4, among others.

In a preferred embodiment of the process according to the invention, identical alkyl halogenides, especially preferably methyl chloride, are used in steps a) and c).

Step c) is carried out in a preferred embodiment in the presence of at least one metal or its compound, preferably of a halogenide that is selected from the group consisting of Cu, Zn, Sn, Al, Fe, Ca, Mn, Ti, Pb, Cr, Mg, Ni, B and P. The elements can be present as metals, compounds, cations or anions in the range from 1 ppm to 30 weight-%. In an especially preferred embodiment of the variation above, one of the named metals or a metal compound is added to step c) by solid discharge from the chlorosilane synthesis reactor (step a). The solid discharge generally consists of Si, Cu-silicide, CuCl, CuCl₂, ZnCl₂, SnCl₄, AlCl₃, FeCl₂, CaCl₂, other types of silicide, types of soot (carbon deposits) and, additionally, traces of the chlorides of Mn, Ti, Pb, Cr, Mg, Ni and P together and, as a rule, also contains one of the named salts. The solid discharge includes all of the solids removed from the reactor for chlorosilane synthesis. They can be introduced completely into step c). According to the invention, however, preferably only one part, namely the so-called fine portion of the named solid discharge is supplied to the reaction in step c). To do this, the solid discharge is generally separated first after it has left the chlorosilane reactor into one or more solid fractions through one or more cyclones. Preferably, only a fraction of the solid discharge with an average particle diameter of less than about 35 μm, preferably about 5 μm is supplied to step c). The entire fine portion of less than 5 μm is especially preferably supplied to step c). The portion of the elementary Si in the fine portion of the solid discharge supplied back to step c) is about 50 to 90 weight-%, the percentage of copper or copper compounds, related to copper is about 1 to 20 weight-%, the percentage of iron or iron compounds related to iron is about 0.5 to 10 weight-%, the percentage of zinc or zinc compounds related to zinc is about 0.05 to about 0.9 weight-%, whereby the named weight data relates to the total quantity of the fine portion of the material discharge. According to experience, at least about 10 mol-% of the metals contained in the fine portion of the solid discharge are present in the form of their halogenides, especially as chloride. Coarse-grained fractions of the solid discharge are preferably sent back to the reactor for chlorosilane synthesis (step a) or precipitated dry separately. The silicon contained in the fine portion is available in step c) to the reaction with the named alkyl halogenides, aryl halogenides and/or chlorosilanes. The process unit c) also serves, on one hand, to absorb the fine portion of the solid material from step a), to evaporate the high-boiling components, to release solid and non-vaporizable components for residue elimination, combustion or hydrolysis and carry out the reaction c). According to the state of the art, the first two process steps are already carried out in this process unit. Because of this, this is found under the name slurry tank or ‘slurry evaporator’ in the literature.

It is assumed that the metals and/or metal compounds and salts contained in the fine portion serve, on one hand, as catalysts of the reaction between the compounds contained in the high-boiling product fraction and the supplied alkyl halogenides, aryl halogenides and/or chlorosilanes and, on the other, as halogenating means, e.g. for acid-containing silicon compounds and/or carbosilane.

The reaction in step c) is preferably carried out in the presence of at least one compound (1) that is selected from the group that consists of tertiary amines or a salt thereof and quaternary ammonia salts. Preferably, the named compound (1) involves tertiary C1 to C12 alkylamines, aliphatic, monocyclic and polycyclic amines and aromatic heterocyclic nitrogen compounds, their salts and the quaternization produces. Especially preferably, compound (1) involves triethylamine, tributylamine, trihexylamine, imidazol and dimethyloctylamine, their salts and their quaternization products. Most preferred is tributylamine. In a preferred variation, the compound (1) used in step c) from the high-boiling fraction resulting from step b) that contains the compound (2) added in step b) selected from tertiary amines or salts thereof and quaternary ammonia salts is entered into step c). If necessary, compounds selected from tertiary amines or salts thereof and quaternary ammonia salts can also be added both in step b) and in step c). The compounds added in step c) act as catalysts for the reaction of the reactive high-boiling compounds in the named high-boiling product fraction. In addition, it is assumed that the named compounds (1) catalyze disproportionating reactions of disilanes and polysilanes, preferably methyl-rich disilanes, to monomer silanes and higher molecular weight oligosilanes. In addition, further catalyzed replacement reactions of chlorine and hydrogen substituents can take place.

The concentration of the compounds (1) and/or (2) in steps b) and/or c) is effectively about 0.3 to 10 weight-%, preferably 0.5 to 10 weight-%, more preferably from 1.5 to 8 weight-% and especially 2.5 and 7 weight-% related to the total quantity of the incoming stream for step b).

The mass of the high-boiling product fraction in step c) resulting from the reaction from step b) is between 0 and 99 weight-% related to the alkyl halogenides, aryl halogenides, high-boiling compounds, monomer chlorosilanes and/or solids.

The mass of the solid discharge from the chlorosilane synthesis reactor preferably used in step c) is preferably between 0 and 70 weight-%, preferably 5 to 30 weight-% related to the quantity of high-boiling product fraction resulting from step b). Related to the total quantity of all the chlorosilanes present in step c), the solid discharge in c) is under 55 weight-%, preferably under 45 weight-%.

Step c) of the process according to the invention is effectively carried out at a temperature of 100 to 300°, preferably 150 to 250° C. and especially preferably in a range from 160 to 240° C. Step c) of the process according to the invention is effectively carried out at a pressure of 1 to 21 bar, preferably 1 to 5 bar.

Since the finest fraction of the solid discharge from the chlorosilane synthesis preferably added in step c) is generally precipitated in the so-called slurry tank, step c) preferably takes place there. Because of this, no additional reaction tank is necessary for implementing step c). In a more preferred embodiment of the invention, the so-called slurry tank is arranged between the chlorosilane reactor and the distillation unit lying downstream of it so that the raw silane stream goes over through solid separators into the slurry tank, from which, after separation of the fine portion of the solid discharge, the raw silane stream that can be evaporated goes to the distillation unit while the especially high-boiling fraction remains in this tank. The high-boiling fraction of the raw silane stream from the distillation unit is supplied to step b) as disclosed above. After step c) is carried out in the slurry tank that lies between the chlorosilane synthesis reactor and the distillation unit, the vaporizable part reacted in step c) of the high-boiling product stream resulting from b) is supplied back to the inlet into b) or transferred out separately. In slurry tank c), in the presence of the fine portion of the solid discharge from stream b) that is present there, the non-vaporizable high-boilers that are brought there with the solids under these conditions are reacted with the alkyl, aryl and/or chlorosilanes so that practically the entire high-boiling product fraction is advantageously supplied to the circuit. At the same time, part of the solid fraction and the non-reacting high-boiling fractions from this reaction tank are released continuously or periodically from this reaction tank for residue disposal. Balanced over all the supply and removal streams, this leads to an especially pronounced reduction of the fraction of the high-boiling product fraction of chlorosilane synthesis.

The process according to the invention of the step-by-step reaction of the high-boilers surprisingly leads to a decrease in the high-boiling fractions in chlorosilane synthesis, especially during the Müller-Rochow synthesis with methyl chloride, in comparison to a single-step reaction of the high-boiling product fraction of the chlorosilane synthesis.

The invention also concerns a process for manufacturing chlorosilanes that comprises the steps:
b) reaction of at least one high-boiling product fraction from chlorosilane synthesis with halogenides and
c) reaction of at least one high-boiling product fraction resulting from step b) with alkyl halogenides, aryl halogenides and/or chlorosilanes.

In this process, steps b) and c) are preferably carried out as explained above.

The invention also concerns a process for reducing the high-boiling product fraction of chlorosilane syntheses that comprises subjecting the high-boiling product fractions from chlorosilane syntheses to steps b) and c) as defined above.

As a result of the reaction sequence described above, halogenated silanes are obtained and, with HCl according to step b), halogenated monomer disilanes and polysilanes are obtained. The yields of the reactions, related to the quantity used and the type of high boiling, separable residues, lie above 71° C. N.D., e.g. at 10 to 90 weight-% for step b) and 3 to 60 weight-% related to the input stream b) for the remaining stream in step c).

The solid suspension formed according to the reaction sequence b)+c) can be burned as usual, hydrolyzed or used to obtain other products. Alternatively, the residue remaining after the reaction can be supplied to a solid/liquid separation in order to obtain other materials accordingly. Finally, after a suitable post-treatment and/or passivation of the chlorosilanes and/or of the pyrophoric solid, a subsequent use or disposal can occur.

The scope of the invention includes the fact that with the use of the procedural method according to the invention, at least two of the processes listed below occur:
catalytic reaction of high-boiling, no longer separable residue with the fine portions and halogen silane/H and/or alkyl halogenides
catalytic disproportionating of disilanes and polysilanes
chlorination of siloxanes
catalytic reaction of silicon fine portions with hydrogen and/or alkyl halogenides.

As a result of reactions in b) and c), the quantity of high-boiling residue that is no longer separable with the process according to step b) and the finest fractions decrease significantly.

The invention will be explained using an example.

### EXAMPLE 1

Process b)

From a raw silane stream of 18 t/h methyl chlorosilanes and 14 t/h methyl chloride, 1.20 t/h high-boiling residues with approx. 48 weight-% of trimethyl trichlorodisilane and dimethyl tetrachlorodisilane (Fr. 3), 31 weight-% of fractions 1 and 2, and 21 weight-% of fraction 4 from Table 1 (remaining high boilers, e.g. >200° C. N.D.) with less than 0.3 weight-% solid is diverted to a reactor consisting of a boiler and a packed column according to process step b). In this reactor, a vaporizable lower-boiling fraction (i.e. MeHSiCl₂, MeSiCl₃, Me₂SiCl₂) and Fr. 1 and 2 and a higher-boiling residue are produced at 150° C. and 4 bar with the addition of 0.135 t/h HCl and 2.8 weight-% tributylamine with 1.2 t/h inlet. The lower-boiling fraction (<150° C. 4 bar) is supplied to the separating unit of step a), the sump return flow (0.096 t/h) of which, consisting of fractions 1 and 2, together with the higher-boiling residue (Fr. 4) produces a product stream (predominantly fractions 1-4) of 0.541 t/h with a content of approx. 10 weight-% of trimethyltrichlorodisilane and dimethyltetrachlorodisilane and 54 weight-% portion of fractions 1 and 2 and 36 weight-% of fraction 4 from Table 1. The rest are the higher-boiling components (Fr. 4 and higher). This residue stream is supplied to reaction step c).

### EXAMPLE 2

### Process step c)

The sump discharge from process step b) of example 1, together with the residue supplied back from the separating unit with e.g. >71° C. N.D. in a quantity of 0.541 t/h high-boiling residues not reacted in step b) and remaining portions of tributylamine and/or their reaction products together with 0.42 t/h fine dust of the MCS synthesis and 0.60 t/h of a vaporizable fraction of disilanes and polysilanes according to fraction 4, additionally contains other higher-boiling components of the Müller-Rochow direct process that are routed into a reaction tank (slurry tank) of process step c). This reaction tank has a temperature of 180° C. and 4 bar pressure. At the same time, the quantity of methyl chlorides and methyl chlorosilanes of the stream of raw silane named in example 1 per vapor pressure equilibrium are also present here.

The products with boiling points under 180° C. at 4 bar leave the tank c), are supplied to the distillation unit discussed for the raw silane stream of step a) in order to separate products with boiling points below 71° C. N.D. by distillation. The products with boiling points over 71° C. N.D. are returned and in stationary status result, together with solids in boiler c), in a residue flow with a quantity of 1.24 t/h that can be continuously released.

This means that the quantity of high-boiling fraction from b), the non-vaporizable residues in c) and the solids in step c), have decreased by 0.321 t/h starting from 1.561 t/h. In total, in steps b) and c) there is a decrease of 0.98 t/h (0.42 t/h solid c+0.6 t/h polysilane inlet into c+1.2 t/h inlet b)−(0.659 t/h product b+0.321 t/h product c)=1.24 t/h residues, i.e. the residue stream was decreased by 0.98 t/h from 2.22 t/h. In this way, the quantity of residues occurring for recycling and/or disposal from the tank in step c) was clearly lowered in comparison to the level without linking of process steps b) and c) according to the invention.

### EXAMPLE 3 (COMPARISON EXAMPLE)

From a raw silane stream of 18 t/h methyl chlorosilanes and 14 t/h methyl chloride, 1.2 t/h high-boiling residues with approx. 48 weight-% of trimethyl trichlorodisilane and dimethyl tetrachlorodisilane (Fr. 3), 31 weight-% of fraction 1 and 2 and 21 weight-% of fraction 4 from Table 1 (remaining high-boilers e.g. >200° C. N.D.) with less than 0.3 weight-% solid is supplied to a reactor consisting of a tank and a packed column. Another remaining part of the non-vaporizable high-boilers of 0.6 t/h brought in with the solid material is left with the solid stream 0.42 t/h in the reactor of step c), the slurry tank. In the reactor for step b), at 150° C. and 4 bar, with the addition of 0.135 t/h HCl and 2.8 weight-% tributylamine with respect to 1.2 t/h inlet, a vaporizable lower-boiling fraction (among others MeHSiCl₂, MeSiCl₃, Me₂SiCl₂) and Fr. 1 and 2) and a higher-boiling residue are produced.

The lower-boiling fraction (<150° C. 4 bar) is supplied to the separating unit in step a), the sump return of which, consisting of portions of fractions 1 and 2 together with the higher-boiling residue, creates a product stream of 0.54 t/h with a content of approx. 10 weight-% portion of fractions 1 and 2 and 36 weight-% of the fraction 4 from Table 1 including higher-boiling components. In contrast to Example 2, this residue stream will not be supplied to reaction step c), but remains for disposal and/or other use.

In contrast to Example 2, reactor c) (slurry tank) receives only the high-boiling partial stream according to the high-boiling fraction 4 and products with still higher boiling points over 180° C. N.D., essentially without fraction 3 (<1 weight-%) that are input with the solid discharge from step a), in a quantity of 0.60 t/h together with 0.42 t/h finest dusts from the Müller-Rochow direct process, 2.8 weight-% tributylamine with respect to 0.6 t/h or the liquid partial flow into c) and with a quantity of methyl chloride and methyl chlorosilane from the above-mentioned raw silane stream present per vapor pressure equilibrium. The reaction tank has a temperature of 180° C. reaction temperature at 4 bar reaction pressure.

At least the products with boiling points up to 160° C. 4 bar leave the tank in order to separate the products with boiling points below 71° C. N.D. in distillative separation of the vapor stream. The products with boiling points over 71° C. N.D. in the static state, together with the solids, result in a residue stream in the tank that remains without recognizable turnover from 0.98-1.02 t/h and is continuously released.

In step b), the residue stream is decreased by 0.541 t/h from 1.2 t/h.

The total turnover through steps b) and c) thus lies at only 0.541 t/h per 2.2 t/h in static condition. Thus, the following results as an equation: (0.42 t/h solids c+0.60 t/h Fr. 4 inlet c+1.2 t/h Fr. 1-4 inlet b)−(0.541 t/h products b+0 t/h products c)=1.679 t/h.

This means that the quantity of the high-boiling fractions, the non-vaporizable residues and solids to be disposed of has been reduced much less than in a process that combines the steps in Examples 1 and 2. Overall, there is a lower decrease of the residue streams in comparison to Examples 1 and 2.

1. Process for manufacturing chlorosilanes, comprising the steps of:
a) reacting silicon with alkyl halogenides, aryl halogenides or hydrogen chloride,
b) reacting at least one high-boiling product fraction from step a) with at least one halogenide and
c) reacting at least one high-boiling product fraction resulting from step b) with one or more compounds selected from the group consisting of alkyl halogenides, aryl halogenides and chlorosilanes.

2. Process according to claim 1, wherein step c) is carried out in the presence of at least one metal compound selected from the group consisting of chlorides of Cu, Zn, Sn, Al, Fe, Ca, Mn, Ti, Pb, Cr, Mg, Ni, B and P.

3. Process according to claim 2, wherein said at least one metal compound is introduced into step c) in the form of the solid discharge, or a part thereof, from the reactor of the chlorosilane synthesis.

4. Process according to claim 1, wherein step c) is carried out in the presence of at least one compound (1) that is selected from the group consisting of tertiary amines or salts thereof and quaternary ammonia salts.

5. Process according to claim 3 or 4, wherein a portion of the solid discharge from the reactor of a chlorosilane synthesis, which portion has an average particle diameter of less than 35 μm, is supplied to step c).

6. Process according to claim 1, wherein step a) is carried out in a fluidized bed reactor.

7. Process according to claim 1, wherein at least one alkyl halogenide is reacted with silicon in step a).

8. Process according to claim 1, wherein said at least one halogenide of step b) is hydrogen chloride.

9. Process according to claim 1, wherein said reaction of the high-boiling fraction in step c) is a reaction with alkyl halogenides and aryl halogenides.

10. Process according to claim 9, wherein said alkyl halogenides are selected from the group consisting of C1 to C8 alkyl halogenides and C2 to C6 alkenyl halogenides; and said aryl halogenide is selected from the group consisting of C6-C10 aryl halogenides.

11. Process according to claim 1, wherein identical alkyl halogenides are used in steps a) and c).

12. Process according to claim 11, wherein said alkyl halogenides used in steps a) and c) are methyl chloride.

13. Process according to claim 4, wherein said compound (1) used in step c) is selected from the group consisting of tertiary C1 to C12 alkylamines, aliphatic, monocyclic and polycyclic amines and aromatic heterocyclic nitrogen compounds, their salts and their quaternization products.

14. Process according to claim 13, wherein said compound (1) is selected from the group consisting of triethylamine, tributylamine, trihexylamine, imidazol and dimethyloctylamine, their salts and their quaternization products.

15. Process according to claim 1, wherein step b) is carried out in the presence of at least one catalytically active compound (2).

16. Process according to claim 15, wherein said catalytically active compound (2) is selected from the group consisting of tertiary amines and salts thereof and quaternary ammonia salts.

17. Process according to claim 16, characterized in that compound (1) used in step c) from the high-boiling fraction resulting from step b) that contains the compound (2) added in step b) selected from tertiary amines or salts thereof and quaternary ammonia salts is entered into step c).

18. Process according to one of claims 4 and 17, wherein the concentration said compound (1), said catalytically active compound (2), or of each is 0.3 to 10 weight-%, relative to the total quantity of the input stream for step b).

19. Process according to claim 1, wherein the mass of the high-boiling product fraction resulting from the reaction in step b) is between 0 and 99 weight-% in step c), relative to the alkyl halogenide, aryl halogenide, high-boiling compounds, monomeric chlorosilanes and/or solids.

20. Process according to claim 3, wherein the mass of the solid discharge from the reactor of the chlorosilane synthesis that is used is between 0 and 70 weight-%, relative to the mass of the high-boiling product fraction resulting from step b).

21. Process according to claim 1, wherein step c) is carried out at a temperature of from 100 to 300° C.

22. Process according to claim 1, wherein step c) is carried out at a pressure of from 1 to 21 bar.

23. Process for manufacturing chlorosilanes comprising the steps of:
a) reacting at least one high-boiling product fraction from a chlorosilane synthesis with halogenides and
b) reacting at least one high-boiling product fraction resulting from step b) with a compound selected from the group consisting of alkyl halogenides, aryl halogenides and chlorosilanes.

24. Process for manufacturing chlorosilanes according to claim 23, wherein the steps b) and c) are carried out as in any one of claims 2-4, 6-17 and 19-22.

25. Process for decreasing the high-boiling product fraction of chlorosilane syntheses that comprises the steps b) and c), as defined in claim 23.

26. Process for decreasing the high-boiling product fraction of chlorosilane syntheses that comprises the steps b) and c), as defined in claim 24.

27. Process of claim 10, wherein said alkyl halogenides are selected from the group consisting of methyl chloride, ethyl chloride, butyl chloride and hexyl chloride, and said alkenyl halogenides are allyl chloride and said aryl halogenides chlorobenzene.
